(19) United States
(12) Patent Application Publication
(10) Pub. No.: US 2011/0029684 A1
(43) Pub. Date: Feb. 3, 2011

(54) STAGGERCASTING WITH TEMPORAL SCALABILITY

(76) Inventors: David Anthony Campana, Princeton, NJ (US); David Brian Anderson, Florence, NJ (US); Alan Jay Stein, Junction, NJ (US)

Correspondence Address: Robert D. Shedd, Patent Operations;THOMSON Licensing LLC, P.O. Box 5312, Princeton, NJ, 08543-5312, US

(21) Appl. No.: 12/736,376

(22) PCT Filed: Apr. 7, 2009
(86) PCT No.: PCT/US09/02168

§ 371 Date: Oct. 2, 2010

Related U.S. Application Data
(60) Provisional application No. 61/123,916, filed on Apr. 11, 2008.

(51) Int. Cl. G06F 15/16

(52) U.S. Cl. 709/231

(57) ABSTRACT

In the transmission of streams of data, such as coded video, staggercasting, in which a primary and a secondary stream are transmitted at some relative time offset (i.e., “staggered”), allows a receiver to pre-buffer frames of the secondary stream to replace frames of the primary stream that may have been lost in transmission. In an illustrative implementation, staggercasting is performed in which the secondary stream contains a subset of the coded video frames transmitted in the primary stream. The primary stream contains reference frames, which are essential to properly decoding the video data, as well as disposable frames which are not. The secondary stream, however, contains copies of the reference frames and may contain copies of some of the disposable frames or no disposable frames at all. When frames of an interleaved stream of the primary and secondary streams are lost, such an arrangement will allow reconstruction at the receiver of an uninterrupted video stream at a temporarily reduced frame rate.

### RELATED PATENT APPLICATIONS

This application claims the benefit under 35 U.S.C. §119(e) of U.S. Provisional Application No. 61/123,916, filed Apr. 11, 2008, the entire contents and file wrapper of which are hereby incorporated by reference for all purposes into this application.

### FIELD OF INVENTION

The present invention generally relates to data communications systems, and more particularly to the transmission of data with time diversity.

### BACKGROUND

Many transmission systems, such as mobile wireless broadcast systems are subject to a difficult physical channel. In addition to fading and Doppler effects, the signal may be entirely obstructed by buildings, trees, poles, and overpasses, among other things. Such conditions can easily cause signal loss for a period of a second or more at a receiver.

To combat these problems, mobile systems frequently use time diversity techniques, such as: interleaving; Long block codes, such as low density parity codes (LDPC) or Turbo codes; convolutional codes; and Multi-Protocol Encapsulation combined with forward error correction (MPE-FEC). Unfortunately, these systems generally incur a delay that is proportional to the time diversity. A user typically perceives this delay in the form of long channel change times, which is highly objectionable to the user.

A type of time diversity technique often used in the transmission of streams of data, such as video data, is staggercasting. Staggercasting offers a method of protection against signal loss by transmitting a secondary, redundant stream which could be time-shifted with respect to a primary stream. This allows a receiver to pre-buffer packets of the secondary stream to replace packets of the primary stream lost in transmission.

Various staggercasting techniques exist that differ in the types of redundant data sent in the secondary stream. For example, the secondary stream may simply be an exact copy of the primary stream staggered with some time offset.

Another staggercasting technique involves the transmission of a secondary stream that is separately encoded from the primary stream. When scalable video coding is not available (for example, with a specification or standard that does not offer a scalable video codec), this secondary stream is completely independent from the primary stream and is simply a separately encoded stream representing the same source video. Because video decoders must typically maintain state data, such as previously decoded reference frames that must be available for decoding future frames, such a staggercasting arrangement requires a receiver to maintain two separate decoder states for each of the streams, placing additional memory burdens on the receiver.

### SUMMARY

We have observed that temporal scalability techniques exist that allow a video stream to be coded such that the stream may be decoded and displayed at multiple frame rates. A video stream that is temporally scalably encoded contains reference frames, from which other frames may be predicted, and additional, non-reference frames. The non-reference frames, commonly referred to as “disposable” frames, are unnecessary for decoding other frames of the video stream and thus may be discarded, resulting in a lower display frame rate for the video.

In an exemplary embodiment of the present invention, staggercasting and temporal scalability techniques are combined to transmit a secondary coded video stream in addition to a primary coded video stream such that the secondary stream contains a subset of video frames from the primary stream. The two streams are transmitted at some time offset (i.e. “staggered”) allowing the secondary stream to be pre-buffered by a receiver to substitute for near future losses of the primary stream.

The impact of losing coded video data is alleviated by transmitting video reference frames in both the primary and secondary streams. Disposable video frames while transmitted in the primary stream, need not be transmitted in the secondary stream if bandwidth is limited. Staggering the two streams in time reduces the likelihood of the secondary stream data being lost along with the primary stream data. A receiver can buffer the secondary stream so that it may fall back on this data when loss of the primary stream occurs.

In a further exemplary embodiment of the invention, different levels of protection can be used in the staggered streams. For example, the secondary stream, which transports the more critical elements, can be provided with a high level of error protection, whereas the primary stream can be provided with a lower level of error protection or no error protection at all.

In view of the above, and as will be apparent from reading the detailed description, other embodiments and features are also possible and fall within the principles of the invention.

### BRIEF DESCRIPTION OF THE FIGURES

Some embodiments of apparatus and/or methods in accordance with embodiments of the present invention are now described, by way of example only, and with reference to the accompanying figures in which:

FIG. 1 is a block diagram of an exemplary staggercasting arrangement in which the present invention can be implemented;

FIG. 2 shows a logical representation of the primary and secondary streams and a multiplexed combination thereof in the staggercasting arrangement of FIG. 1;

FIG. 3 shows an illustrative scenario in which data loss occurs in the multiplexed combination of FIG. 2 and in which data is reconstructed at a receiver in accordance with the principles of the invention.

### DESCRIPTION OF EMBODIMENTS

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

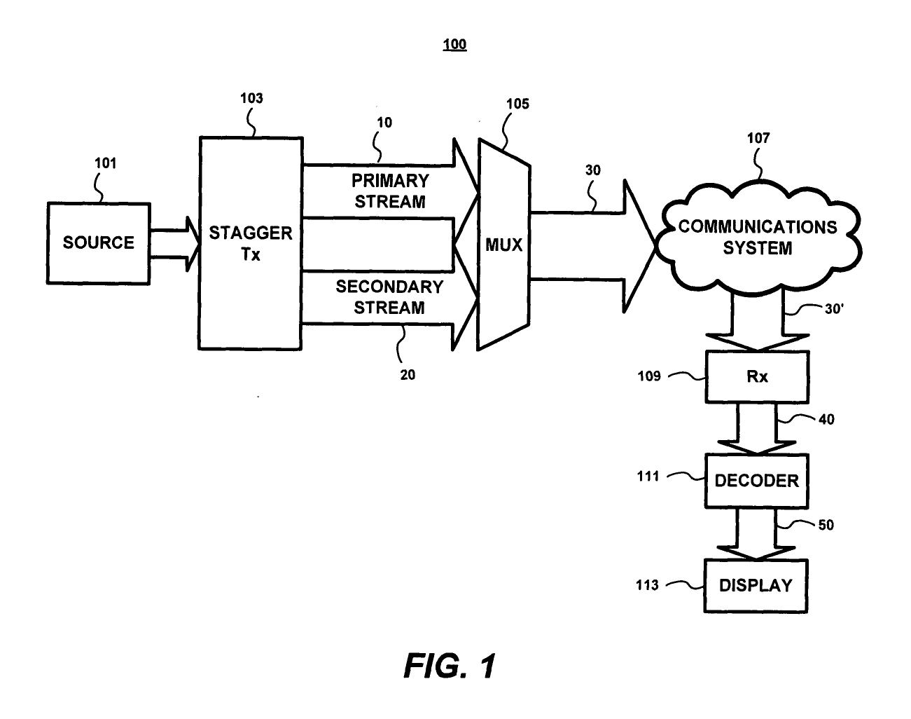

FIG. 1 is a block diagram of an illustrative arrangement 100 comprising: a stagger transmitter 103; a multiplexer (MUX) 105; a communications system 107, which may include a variety of elements (e.g., networking, routing, switching, transport) operating over various media (e.g., wireline, optical, wireless); and a receiver 109. A source 101, such as a video encoder, provides an original stream of data units to the stagger transmitter 103, which, in turn, provides a staggercast transmission to the MUX 105. The output of the MUX 105 is coupled to a bandwidth-limited transmission channel carried by the communications system 107 to the receiver 109. The receiver 109 is, in turn, coupled to additional components, such as a video decoder 111 for decoding the received data. Additionally, the video decoder 111 may be coupled to a display apparatus 113 for displaying the decoded video data. Note that in this embodiment, each data unit may contain encoded video data for a frame, a portion of a frame or multiple frames of a video stream. Additionally, the video stream is assumed to be a temporally scalable video stream, containing reference frames, and disposable, non-reference frames. As discussed, reference frames are frames from which other frames may be predicted and are considered non-disposable for the provision of uninterrupted video. The non-reference frames are unnecessary for decoding other frames of the video stream and thus may be discarded, resulting in a lower display frame rate for the video. A temporally scalable video standard is set out in ITU-T Recommendation H.264 and ISO/IEC 14496-10 (MPEG-4 part 10) Advanced Video Coding, October 2004.

Note that while the embodiment described is for a video implementation, the principles of the present invention can be applied to systems handling a variety of temporally scalable data, such as for example, audio data.

The staggercast transmission from the transmitter 103 to the MUX 105 comprises two streams. One stream, the primary stream 10, corresponds to the original stream from the source 101 and the other stream, the secondary stream 20, can be a copy of all or a portion of the primary stream. The secondary stream 20 can be time-shifted or staggered relative to the primary stream 10, in which case it may also be referred to as a “staggered” stream. Staggering allows the receiver 109 to pre-buffer data units of the secondary stream 20 so that they may replace corresponding data units in the primary stream 10 that may have been lost or corrupted in transmission.

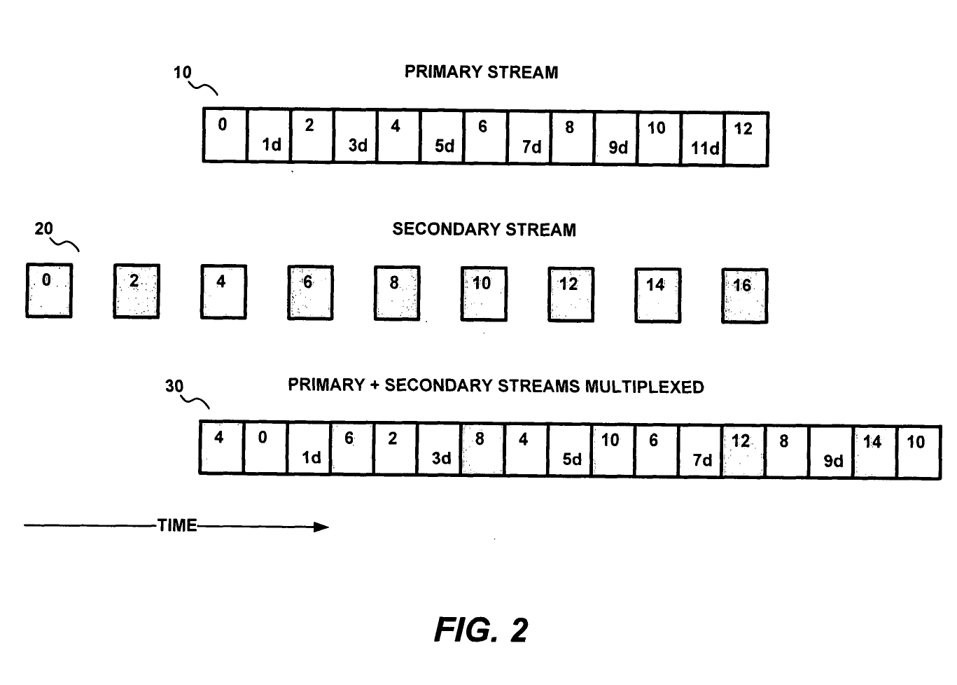

In the exemplary arrangement of FIG. 1, the MUX 105 interleaves the primary and secondary streams 10, 20, into a single output stream 30 for transmission by the communications system 107 to the receiver 109. The bandwidth of the output stream 30 will typically be greater than that of each of the primary and secondary streams 10, 20. The portion of the bandwidth of the output stream 30 allocated to each of the primary and secondary streams can be determined by the stagger transmitter 103 and/or the MUX 105. For example, the primary and secondary streams as generated by the stagger transmitter 103 may have the same bandwidth, with the secondary stream 20 containing a copy of each data block of the primary stream 10. The MUX 105, however, may select a subset of data units in the secondary stream 20 for inclusion in the output stream 30. Alternatively, the stagger transmitter 103 may generate the secondary stream 20 so that it contains a subset of the data units of the primary stream 10, with the MUX 105 passing on the data units it receives on the primary and secondary streams to the output stream 30. Such a scenario is illustrated in FIG. 2.

FIG. 2 shows a logical representation of the primary stream 10, the secondary stream 20, and the combined output stream 30 as transmitted through time in accordance with the principles of the invention. Primary stream data units are represented by white blocks whereas secondary stream data units are represented by shaded blocks. A given block in the secondary stream 20 is a copy of the corresponding block with the same numerical designation in the primary stream 10 (e.g., secondary block “0” and primary block “0” represent the same video frame(s) and contain the same data).

In the illustrative scenario of FIG. 2, the primary stream 10 contains all of the data units in the original stream from the source 101, whereas the secondary stream 20 contains only every other data unit, i.e., the even-numbered units. As discussed above, some data units, such as those containing reference frames, are non-disposable, whereas other data units are disposable. In the example of FIG. 2, the odd-numbered blocks represent disposable data units, also marked with a “d” for the sake of clarity, and the even-numbered blocks represent non-disposable data units.

FIG. 2 demonstrates two important characteristics of the exemplary embodiment of the present invention. First, the secondary stream 20 contains only copies of non-disposable frames from the primary stream 10 and no disposable frames. Second, the secondary stream 20 is staggered earlier in time from the primary stream allowing a receiver to buffer this redundant data in order to replace lost data units of the primary stream.

In the example shown in FIG. 2, the offset between the two streams is shown as four data units; i.e., the secondary stream 20 is transmitted four data units earlier than the primary stream 10. For simplicity, all data units are shown in FIG. 2 to have the same transmission time. In practice, however, the size of a coded frame will vary substantially from frame to frame and thus so will the transmission time of each frame (or data unit, in FIG. 2.) In practice, the stagger offset is typically expressed in terms of time rather than frames; e.g., the secondary stream frames may be transmitted four seconds earlier than their primary stream equivalents. The invention is not limited to any specific time offset. The preferred time offset for a given implementation will depend on implementation-specific details such as, for example, available memory at the receiver for buffering and characteristics of the error loss. Additionally, the secondary stream can be staggered later in time from the primary stream. For practical reasons, however, the secondary stream should preferably precede the primary stream. Given that the secondary stream provides protection against loss of the primary stream, transmitting the secondary stream later in time from the primary stream would result in the protection coming some time after a data loss. Either at initial playback or upon the first loss event, the primary stream would have to pause to wait for the replacement data units from the stagger stream to arrive, resulting in a diminished viewer experience. When the secondary stream is offset earlier in time from the primary stream, as shown, the receiver can immediately begin playback of the unprotected primary stream while buffering the secondary stream to protect against future loss.

In an exemplary embodiment, the primary and secondary streams may be provided with error protection (e.g., turbo codes, forward error correction, etc.) Both or only the secondary stream may be provided with error protection. The two streams may also be provided with different levels of error protection, with the secondary stream preferably being provided with a higher level of protection. It would be possible to reduce the overhead of an error protection scheme by applying it only to the secondary stream. This also offers the advantage of allowing the receiver to immediately decode and play the unprotected primary stream. Since the secondary stream is preferably received before the primary stream, there should be sufficient time to correct errors in any secondary stream data units before they may be needed to replace any lost primary stream data units.

Referring again to FIG. 2, stream 30 shows the primary and secondary streams as they may be combined for transmission in an illustrative embodiment of the invention. As represented by stream 30, the primary and secondary streams 10, 20 are time multiplexed for sequential transmission over a single physical channel. FIG. 2 shows one example of the interleaving of the primary and secondary streams in which one secondary stream data unit is transmitted followed by two primary stream data units. As can be appreciated in view of the present description, a variety of interleaving patterns and ratios of primary to secondary data units are possible and contemplated by the present invention.

Note that in the arrangement shown in FIG. 1, the source 101 provides a single stream which is re-transmitted by the transmitter 103 as part of a staggercast transmission of two streams. This, however, is only one of a variety of possible arrangements to which the principles of the present invention can be applied. For example, an arrangement in which the source 101 generates a staggercast transmission (with two streams) which is then received and re-transmitted by one or more staggercast transceivers could also be used with the present invention. A variety of combinations of the source 101, stagger transmitter 103 and MUX 105 are contemplated by the present invention.

Moreover, in some applications, a secondary stream as contemplated by the present invention may already be available, as opposed to being generated by a stagger transmitter, as shown. For example, a specification may define multiple profiles for the transmission of content to mobile devices. These profiles can vary from very low resolution/frame rate/bitrate streams for viewing on simple mobile phones with small screens to higher resolution/frame rate/bitrate streams for mobile devices better capable of presenting video (having a larger screen, more powerful decoder, etc.) A system may simultaneously transmit a given video program in both profiles on the same channel so that users of either type of device may receive video that is optimal for their respective devices. In such an application, an embodiment of the present invention would allow the more powerful device to use the simpler stream as the secondary stream in order to provide substitute video for time periods of data loss. This would entail identifying the simpler stream as the secondary stream and transmitting it at a time offset relative to the primary stream. Such an implementation has the benefit of not requiring any additional bandwidth on the channel since the secondary stream already exists.

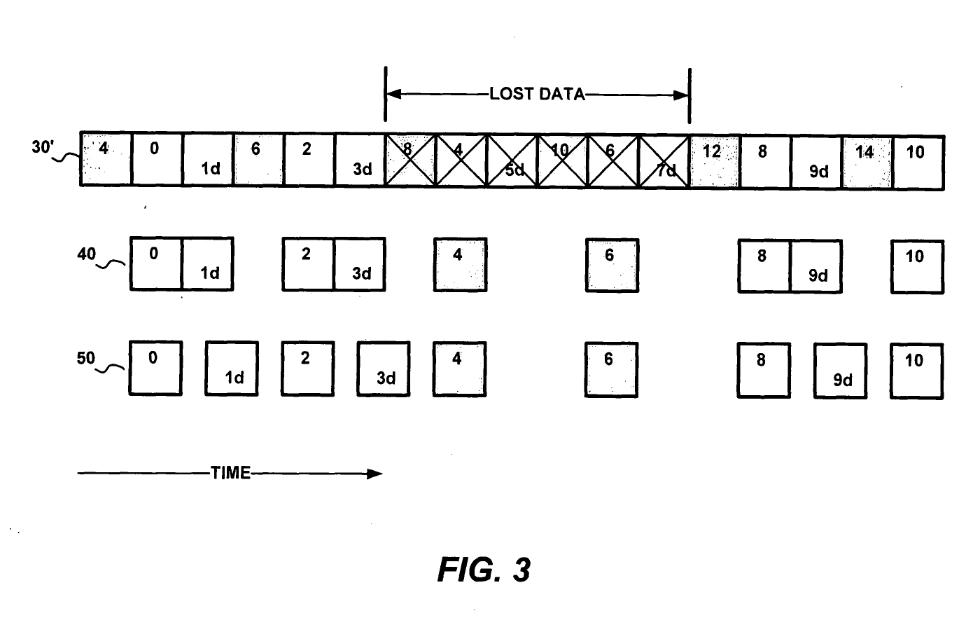

Referring now to FIG. 3, this figure shows an illustrative scenario illustrating principles of the invention as applied to the example transmission stream 30 of FIG. 2. In the scenario shown, in the course of conveying the stream 30 via the communications system 107 to the receiver 109, a loss of data occurs, so that the receiver receives stream 30′, a version of the original stream 30 with some data units missing. In this scenario, six contiguous units of data are lost: four primary stream units, 4, 5d, 6 and 7d; and two secondary stream units, 8 and 10.

The receiver 109, using the redundant secondary stream data units contained in the received stream 30′, can reconstruct all or some of the primary stream data units for which copies were included in the secondary stream. In FIG. 3, the sequence 40 represents the sequence of data units reconstructed by the receiver 109 from the primary and secondary stream data units in stream 30′, and presented by the receiver 109 to the decoder 111. Note that the data units in sequence 40 are in their logical order. As shown by sequence 40, because secondary stream data units 4 and 6 were sent before the loss of data, these secondary stream data units are presented to the decoder 111 in place of the lost primary stream data units. Also, since there were no copies of the disposable data units 5d and 7d in the stream 30′, these data units are not reconstructed and are lost.

Upon processing the sequence of reconstructed data units 40, the decoder 111 presents the frames of decoded video to the display 113, as represented by the sequence 50. Sequence 50 shows the reconstructed sequence of data units containing the frames of video data presented for display and indicates the timing with which the frames are displayed. As indicated by the sequence 50, for the duration of the lost data, the frame rate is approximately cut in half, which typically may be perceived by a viewer as a short period of less fluid motion. The visual impact of missing disposable frames should be minimal given that the disposable frames are, by definition, not used as reference frames and thus their loss does not impact any other frames in the stream, as a missing reference frame would. Although it should not be necessary to reconstruct or conceal the missing frames, implementation of the present invention, however, does not preclude such measures.

As can be appreciated, the performance of the above-described arrangement will depend on a variety of factors, including the degree of redundancy provided in the secondary stream and the duration of data loss events. For example, the frame rate of the video generated from the reconstructed sequence 40 of data units will depend on the degree of redundancy provided by the secondary stream 20 in the combined stream 30. If, for example, the secondary stream 20 contains copies of all data units in the primary stream 10, i.e., disposable as well as non-disposable units, it is possible that all data units lost in transmission can be reconstructed at the receiver 109, so long as no staggered copy of a lost data unit is lost as well. For applications in which a temporarily reduced frame rate can be tolerated, only non-disposable data units can be provided in the secondary stream 20, as described above.

Embodiments of the present invention enjoy several advantages over known approaches. As mentioned above, one staggercasting method involves the transmission of a secondary stream that is separately encoded from the primary stream. When scalable video coding is not available (for example, with a specification or standard that does not offer a scalable video codec), this secondary stream is completely independent from the primary stream and is simply a separately encoded stream representing the same source video. Typical video decoders must maintain state data, such as previously decoded reference frames that must be available for decoding future frames that are predicted from them. Where the primary and secondary streams are independent, a receiver would need to maintain two separate decoder states for each of the streams, placing additional memory burdens on the receiver. The exemplary arrangement of the present invention described above can be implemented with only one decoder and associated state memory given that the two streams are related; i.e., the secondary stream is a subset of the primary stream.

The principles of the present invention may be combined with other staggercasting methods. For example, staggercasting may be used with spatially scalable video streams such that both the lower resolution base layer stream and the higher resolution enhancement layer stream are provided in the primary stream while the lower resolution base layer stream is provided in the staggered secondary stream. This would provide protection for the base layer while saving on bandwidth by not duplicating the enhancement layer as well.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, the inventive concept may be implemented in a stored-program-controlled processor, e.g., a digital signal processor, which executes associated software for carrying out a method in accordance with the principles of the invention. Further, the principles of the invention are applicable to other types of communications systems, e.g., satellite, Wireless-Fidelity (Wi-Fi), cellular, etc. Indeed, the inventive concept is also applicable to stationary as well as mobile receivers. It is therefore to be understood that numerous modifications may be made to the illustrative embodiments and that other arrangements may be devised without departing from the spirit and scope of the present invention.

1-7. (canceled)

8. A method of processing a stream of data units comprising:
receiving a combined stream of data units, the combined stream of data units containing:
a primary stream of data units, the primary stream of data units containing disposable and non-disposable data units, and
a secondary stream of data units, the secondary stream of data units containing the non-disposable data units contained in the primary stream of data units,
wherein the primary and secondary streams of data units have a time offset between them; and
wherein a portion of the received combined stream of data units has corrupted non-disposable data units;
reconstructing a sequence of data units from the primary and secondary streams such that corrupted non-disposable data units from a primary stream portion of the combined stream are replaced with corresponding non-disposable data units from the secondary stream.

9. The method of claim 8, wherein the data units contain temporally scalable coded video data, the non-disposable data units of the primary and secondary streams containing data representing reference frames.

10. The method of claim 8, wherein the time offset primary and secondary streams of data units are time multiplexed in the combined stream of data units.

11. The method of claim 8, wherein the time offset between the primary and secondary streams of data units is such that the secondary stream precedes the primary stream.

12. The method of claim 8, wherein the data units contain at least one of video and audio data.

13. The method of claim 8, wherein the secondary stream of data units are provided with error protection, the method comprising correcting errors in the primary stream of data units in the received portion of the combined stream of data units.
